(19) United States
(12) Patent Application Publication
(10) Pub. No.: US 2007/0048481 A1
(43) Pub. Date: Mar. 1, 2007

(54) Adhesive doily

(76) Inventor: Donnarose Melvin, Spring Lake Hts., NJ (US)

Correspondence Address: Donnarose Melvin, 9 Royal Court Drive-J3, Spring Lake Hts., NJ, 07762, US

(21) Appl. No.: 11/508,518

(22) Filed: Aug. 23, 2006

Related U.S. Application Data
(60) Provisional application No. 60/712,737, filed on Aug. 30, 2005.

(51) Int. Cl. B32B 33/00

(52) U.S. Cl. 428/40.1; 428/195.1

(57) ABSTRACT

An adhesive doily is provided. The adhesive doily may be decorative and of various shapes and sizes and includes an adhesive backing that is easily releasable and preferentially adheres to the doily when the doily is removed from a surface. The gentle adhesive enables placement, release, and repositioning of the adhesive doily without damage to or residual adhesive remaining on the receiving surface. Surfaces of choice may be enhanced by adhesive doily which remains stationary once placed on same.

### RELATED APPLICATION

This application claims priority of U.S. provisional application Ser. No. 60/712,737 filed Aug. 30, 2005, the contents of which are hereby incorporated into this application by reference, as if set forth in their entirety.

### FIELD OF THE INVENTION

This invention relates to improved doilies, in particular, doilies with adhesive backings.

### BACKGROUND

Doilies are widely used for functional and aesthetic purposes. Such doilies come in various shapes, sizes, colors and prints, and are typically placed under food items or potted plants, under and over plates or platters, or as stand alone functional or decorative items. Many craft items are delightfully created with doilies as well. Doilies with improvements or enhancements such as protective coatings are popular.

Conventionally available doilies have optimally served the purpose of accentuation and enhancement for the presentation of food products and the other aforementioned aspects. One shortcoming of conventional doilies is that they do not remain in their desired position when objects are being positioned above them, or when the doily and associated food or other products are being transported. Whether placing a baked cake or other food product on a doily, or taking the food product out of a box after purchase, the doily frequently shifts, and/or becomes lopsided or wrinkled which undesirably produces the opposite effect of enhancing appearance or presentation. Moreover, the cake or other food product may be damaged when a large part of the doily shifts with respect to the cake or other food product due to the movement while in transit, and when the user attempts to lift the cake to reposition the doily back to the center of the plate. The effectiveness of the doily is generally diminished when it moves from its desired position. It would therefore be desirable to provide a doily that remains in position.

Doilies are also used in creating craft products. When used for craft products, it would be advantageous to have a doily that remains in position to simplify the initial attachment of the doily to objects for craft projects. It would be desirable to have a doily that easily adheres on its own initially, thereby reducing or precluding the need to use a permanent adhesive. This alleviates the need to use excess glue which can become extremely messy and may result in many doilies being wasted. Hence, there is also a need in the art of craft products for a doily that remains in position.

### SUMMARY OF THE INVENTION

It is an object of the invention to provide an improved doily with an adhesive backing.

One aspect of the invention is a gentle adhesive on the backside of the doily. The doily releasably adheres to a variety of surfaces. The adhesive preferably remains on the back of the doily and releases from the surface from which the doily is removed. Hence, placement and release, and repositioning of the same is done with ease and without damaging or soiling the surface from which it is placed. Damage to the doily is also prevented. Once the doily is positioned, it remains stationary due to the adhesive.

In one embodiment, to protect the bottom of the adhesive doily, a protective backing sheet may be attached behind the adhesive backing. The protective backing may conform to the size of the doily or it may be sized differently. The adhesive backing allows the doily to remain stationary whether used in conjunction with other items, such as a cake or other food items, as well as with craft or non-craft items, or when standing alone.

In further embodiments of this invention, provided is a plurality of stacked adhesive doilies which are joined by their respective adhesive backings to form a pad. In this embodiment, a protective backing sheet may be provided for the bottom adhesive doily of the stack.

### BRIEF DESCRIPTION OF THE DRAWINGS

The invention is best understood from the following detailed description when read in conjunction with the accompanying drawing. It is emphasized that, according to common practice, the various features of the drawing are not necessarily to scale. On the contrary, the dimensions of the various features may arbitrarily be expanded or reduced for clarity. Like numerals denote like features throughout the specification and drawing. Included are the following figures:

FIG. 1 is a top view of an exemplary round adhesive doily.

FIGS. 2-6 are bottom views of exemplary adhesive doilies of various shapes and with the adhesive backings provided in various configurations. Doilies of other shapes may also be used.

FIG. 7 shows an exemplary stack or pad of the inventive doilies with adhesive backings.

### DETAILED DESCRIPTION OF PREFERRED EMBODIMENTS

Provided is an adhesive doily that includes a doily with an adhesive backing that when placed on a surface, enables it to remain stationary, and yet is easily released if repositioning is desired. The adhesive doily is reusable as the adhesive advantageously remains on the backside of the doily when the doily is disengaged from the surface upon which the doily is initially positioned. The adhesive doily may be used on, i.e., placed on, surfaces including but not limited to glass, ceramic, paper, plastic, Formica, wood, cloth, wicker, and/or other similar surfaces.

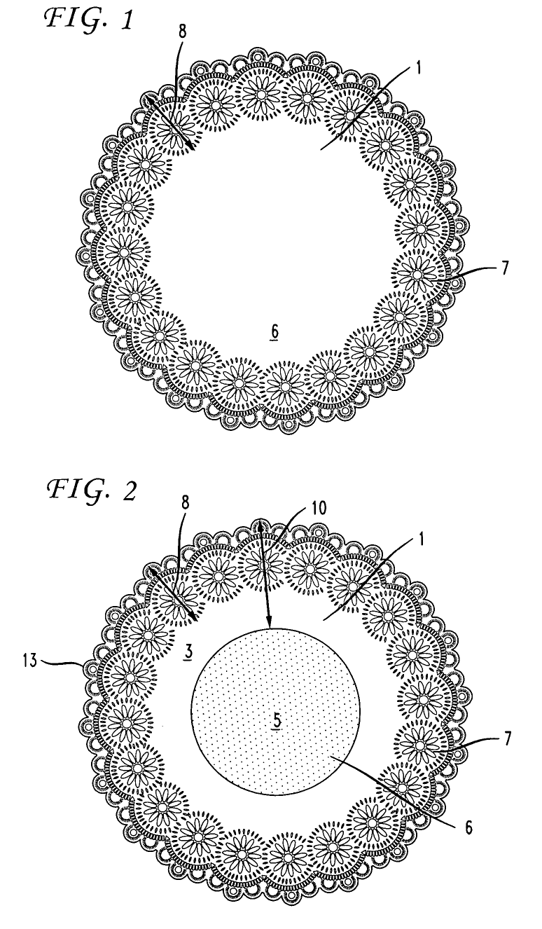

FIG. 1 illustrates a top view of an exemplary, generally round adhesive doily 1 which may be formed of paper or other suitable materials. Adhesive doily 1 may be various colors and various sizes. When viewed from above, this circular configuration reveals a shape of a lacey pattern where sections over entire surface are intricately raised forming shapes arranged in a flowing manner. Outer portion 7 surrounds central portion 6 and is the patterned peripheral portion in the embodiment illustrated in FIG. 1. Some of the shapes on outer portion 7 are formed using cut out portions and resemble embroidery. Adhesive doily 1 may be generally flat or it may include corrugations, ridges or other raised sections throughout doily 1 or only in portions of adhesive doily 1, such as in outer portion 7, which includes distance 8 and forms the periphery. This circular pattern is well suited for some of the more general uses which may be under and/or over any type of plate and/or platter, or placed on a counter or any desired surface to enhance presentation, and may be useful for various types of decorations and craft creations.

In other exemplary embodiments, adhesive doily 1 may be configured in the shape of a square, rectangle, oval, heart, star, diamond, or other suitable shapes and may include various patterns, textures and prints. Examples of patterns, textures and prints that may appear on the doily, whether solid, cut out or composed of a picture, can be theme related or not, such as landscapes, action figures, cartoons, flowers, rainbows, animals, cherubs, famous art, quotes, personalized messages, geometric shapes, astrology, famous faces, hearts, glitter, and gel with glitter or any shiny substance.

Adhesive doily 1 is not limited to one color or size. Typical sizes can range from 4 to 12 inches in diameter, but other sizes may be used alternatively. Examples of the composition of the adhesive doily 1 include recycled or other paper, or other synthetic or natural material such as linen, cotton, etc. The thickness of adhesive doily 1 may vary depending on purpose or use. The front surface of adhesive doily 1 may be advantageously coated with a suitable laminate or other protective coating to protect from water damage, staining and the like.

FIG. 2 illustrates adhesive 5 on backside 3 of adhesive doily 1, the top surface of which was illustrated in FIG. 1. In one exemplary embodiment, backside 3 of adhesive doily 1 may be completely or partially coated with various suitable and conventional materials such as laminates that protect the surface and backing of the adhesive doily from water, dust, debris or damaging particles, and according to this exemplary embodiment, adhesive 5 may be formed on the coating or on a portion of the doily void of the coating. As is commonly known in the art, the backside 3 of adhesive doily 1 may alternatively be referred to as the bottom due to the typical use configuration of adhesive doily 1. Hence, the terms back and bottom may be used interchangeably herein.

It can be seen that outer portion 7 of adhesive doily 1 is free of adhesive. Backside 3 of adhesive doily 1 includes adhesive 5 disposed in one solid circular pattern centrally positioned on adhesive doily 1 but absent from outer portion 7 of adhesive doily 1. In one exemplary embodiment distance 8 of outer portion 7 may be approximately 1.5 inches around the entire perimeter of the doily but other distances may be used in other exemplary embodiments. Distance 10 that is adhesive-free may vary in exemplary embodiments and may be less than or greater than distance 8 of outer portion 7. Distance 10 may range from 0.125 to 3 or 4 inches in various exemplary embodiments. Adhesives of various suitable compositions may be used. The adhesive can be formed in many shapes, solid or separated by spaces, and may cover the entire back of the adhesive doily or only a portion thereof, such as illustrated in FIGS. 2-6 which are exemplary only. Outer portion 7 and peripheral edge 13 of adhesive doily 1 may be free of adhesive in varying distances up to where the adhesive begins from the center.

In other exemplary embodiments, adhesive doily 1 may include a pattern formed of cut-outs throughout the doily, and adhesive 5 may be disposed centrally or in other locations.

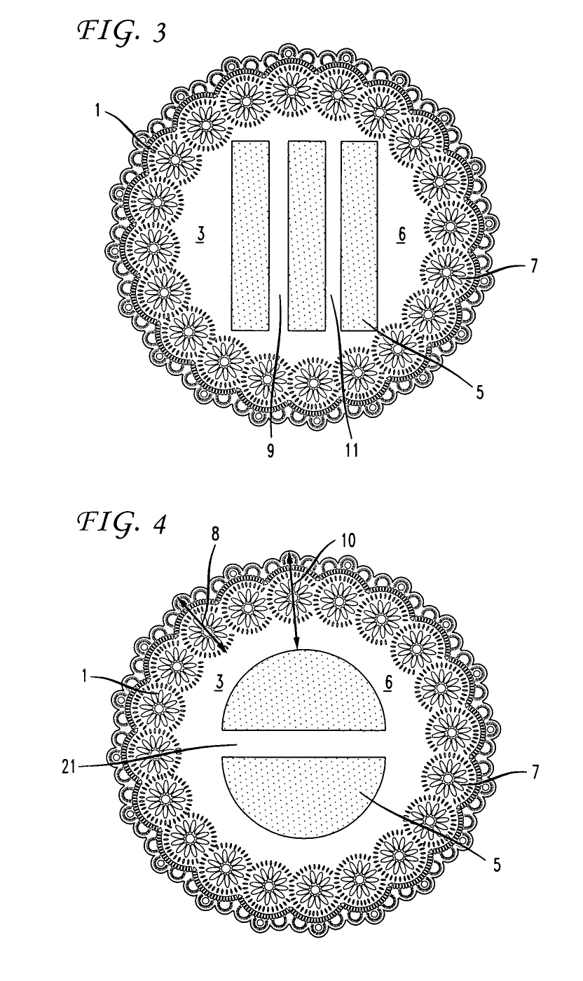

One exemplary embodiment illustrated in FIG. 3, illustrates adhesive 5 centrally disposed on central portion 6 of backside 3 of doily 1 in parallel strips vertically positioned but absent from outer portion 7 and such arrangement facilitates easy release. The strips of adhesive 5 are spaced apart by spacing 9 and spacing 11 on backside 3 of adhesive doily 1. In one exemplary embodiment, the strips may include a width ranging from 0.25 to 2 inches and spacing 9 and spacing 11 may vary from 0.125 to 2 inches in an exemplary embodiment. In another exemplary embodiment, the strips of adhesive 5 may be angled with respect to each other.

FIG. 4 illustrates adhesive 5 on backside 3 of adhesive doily 1. Adhesive 5 is disposed in two solid half-circles centrally positioned on central portion 6 of adhesive doily 1 but absent from outer portion 7. The two solid half circles are separated by space 21. Distance 10 may range from approximately 1-3 inches around the entire perimeter of the doily, in one exemplary embodiment.

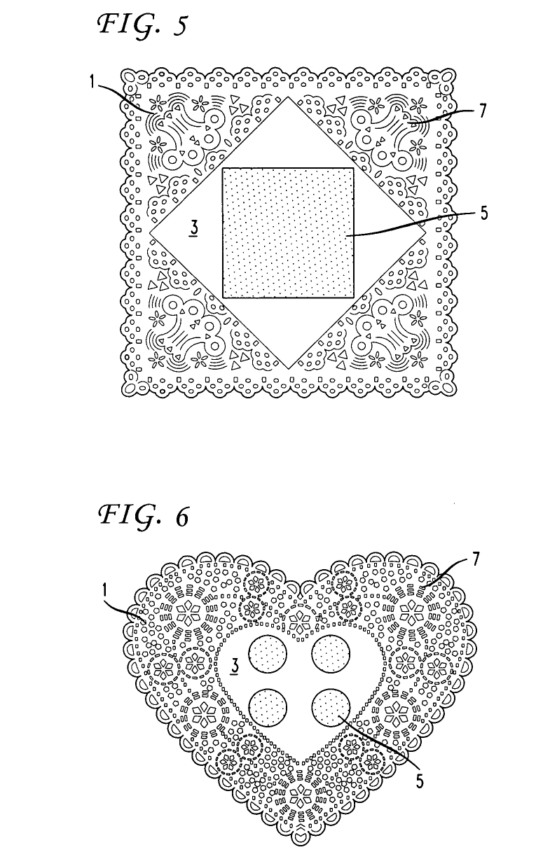

FIG. 5 illustrates adhesive 5 on backside 3 of generally rectilinear adhesive doily 1. Outer portion 7 of adhesive doily 1 is free of adhesive. Backside 3 of adhesive doily 1 includes adhesive 5 disposed in one solid square pattern centrally positioned on doily 1 but absent from outer portion 7 of doily 1. Adhesive 5 may be positioned alternatively in other exemplary embodiments.

FIG. 6 illustrates adhesive 5 centrally disposed on backside 3 of heart-shaped doily 1 in four solid circles centrally positioned on adhesive doily 1. In this illustrated embodiment, the center points of the adhesive circles form a rectangle, but other arrangements may be used alternatively. The circles of adhesive 5 may be of any suitable size.

Various adhesives may be used as adhesive 5 which preferentially adheres to backside 3 of adhesive doily 1 when adhesive doily 1 is removed from a surface or from a subjacent adhesive doily 1. In one exemplary embodiment, the type of adhesive on the back of the exemplary adhesive doily may be similar or identical to that used on the back of a Post-it® Note made by 3M Company of St. Paul, Minn. Similar types of adhesives such as would ease the process of placing and releasing and which preferably remains adhered to the doily when the doily is removed from a surface may be advantageously used. The adhesive doily may be removed without damaging or leaving adhesive debris on the surface on which it is placed, and remains stationary when repositioned, i.e., it may be reused.

To protect adhesive 5 on backside 3 of adhesive doily 1 and to facilitate packaging and storage, a suitable paper backing sheet may be provided over adhesive 5. The backing sheet may conform to the shape of adhesive doily 1 or include different shapes and sizes and allows for easy release of adhesive doily 1 due to the nature of adhesive 5 which preferably adheres to backside 3 of adhesive doily 1.

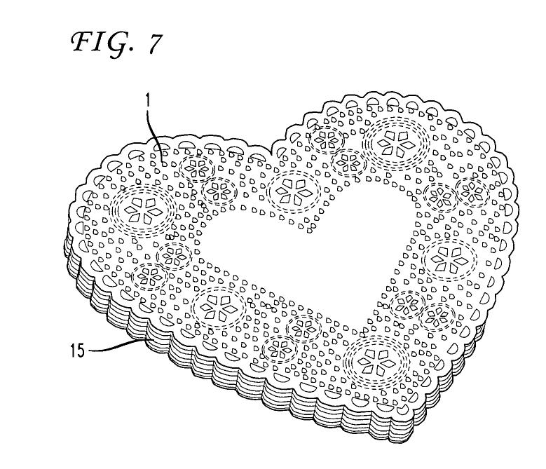

FIG. 7 illustrates a top view of stack 15 of a plurality of adhesive doilies 1 that remain positioned as such by their adhesive backing, resembling a pad or stack of Post-it® Notes. The bottom stacked adhesive doily 1 also includes adhesive 5 on backside 3 thereof (not illustrated in FIG. 7). Stack 15 may be formed of heart shaped or alternatively configured adhesive doilies 1 in the form of a pad and in other exemplary embodiments, the adhesive doilies 1 that make up stack 15 may take on other shapes. The configuration and type of adhesive on each stacked adhesive doily 1 can comprise any adhesives previously described. To facilitate packaging as well as storage, and protect bottom stacked adhesive doily 1, a paper (or other suitable material) backing sheet (not illustrated in FIG. 7) as mentioned above may be advantageously provided. Alternatively, bottom stacked adhesive doily 1 can be void of adhesive, hence providing the same protection and facilitation of packaging and storage, thereby eliminating the backing sheet. In the illustrated embodiment, each adhesive doily 1 of stack 15 is of the same size and shape and the adhesive doilies 1 are aligned with one another.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the item be constructed, arranged or used in a particular orientation.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An adhesive doily comprising a doily with an adhesive on a bottom surface thereof, the adhesive enabling the doily to remain stationary on a surface.

2. The adhesive doily as in claim 1, wherein the adhesive remains on the bottom surface of the doily when the doily is disengaged from being disposed on the surface.

3. The adhesive doily as in claim 1, wherein at least one of the bottom surface and an opposed top surface comprises a water-resistant coating.

4. The adhesive doily as in claim 1, further comprising a protective backing sheet joined subjacent the adhesive.

5. The adhesive doily as in claim 1, wherein substantially the entire bottom surface includes the adhesive thereon.

6. The adhesive doily as in claim 1, wherein the adhesive is formed only on a portion of the bottom surface.

7. The adhesive doily as in claim 6, wherein the adhesive is centrally disposed and a peripheral portion of the doily is completely void of the adhesive, the peripheral portion extending completely around a periphery of the doily and extending inwardly about 1-2 inches from a peripheral edge.

8. The adhesive doily as in claim 1, wherein said adhesive comprises at least two centrally disposed strips.

9. The adhesive doily as in claim 1, wherein said centrally disposed strips are parallel to one another.

10. The adhesive doily as in claim 1, wherein said adhesive is formed in a circular pattern.

11. The adhesive doily as in claim 1, wherein the adhesive comprises a plurality of non-rectilinear shapes.

12. The adhesive doily as in claim 1, wherein the plurality of non-rectilinear shapes comprise a plurality of circles.

13. The adhesive doily as in claim 1, wherein the adhesive comprises a plurality of concentric circles and a peripheral portion of the doily is completely void of the adhesive, the peripheral portion extending completely around a periphery of the doily and extending inwardly about 1-2 inches.

14. An adhesive doily comprising a doily with a top surface and an adhesive disposed on a bottom surface thereof such that the adhesive prevents movement of the doily when the doily is disposed on a receiving surface and remains on the bottom surface and not the receiving surface when the doily is disengaged from the receiving surface.

15. The adhesive doily as in claim 14, wherein the adhesive is only centrally disposed on the bottom surface and an outer portion extending completely peripherally around the doily, is free of the adhesive for a distance extending about 1-2 inches from a peripheral edge of the doily.

16. A stack of doilies comprising a plurality of adhesive doilies each with an adhesive bottom surface, the adhesive doilies joined by their respective adhesive bottom surfaces.

17. The stack of doilies as in claim 16, wherein a bottom of the stack contains a protective backing sheet thereunder.

18. The stack of doilies as in claim 16, further comprising a non-adhesive doily joined to an underside of the adhesive doily that forms the bottom of the stack.

19. The stack of doilies as in claim 16, wherein each of the doilies comprises the adhesive being centrally disposed and in the form of a circle, a peripheral portion of the doily being completely void of the adhesive, the peripheral portion extending completely around a periphery of the doily and extending inwardly about 1-2 inches from a peripheral edge.

20. The stack of doilies as in claim 16, wherein each of the adhesive doilies has the same size and shape and the adhesive doilies are aligned over one another.
